(19) United States
(12) Patent Application Publication
(10) Pub. No.: US 2009/0037588 A1
(43) Pub. Date: Feb. 5, 2009

(54) Method And System For Providing Status Information Of At Least Two Related Principals

(76) Inventor: Robert P. Morris, Raleigh, NC (US)

Correspondence Address: SCENERA RESEARCH, LLC, 111 Corning Road, Suite 220, Cary, NC, 27518, US

(21) Appl. No.: 11/831,276

(22) Filed: Jul. 31, 2007

(51) Int. Cl. G06F 15/16

(52) U.S. Cl. 709/227

(57) ABSTRACT

Methods and systems are described for providing status information of at least two related principals. One method includes establishing an association between a first tuple including a first status for a first principal and a second tuple including a second status for a second principal, where the association includes a relationship indicator indicating a relationship between the first principal and the second principal. A first subscription to the first tuple for receiving the first status for the first principal is provided for a first watcher entity. In response to providing the first subscription, the method includes generating a first notification message including status information comprising at least one of a composite status based on the first status for the first principal, the second status for the second principal and the relationship indicator; and the first status, the second status and the relationship indicator.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

Typically, status services store data entities, known as tuples that are associated with principals that can represent users, applications, entities or devices. A tuple, in its broadest sense, is a data object containing one or more elements. If a tuple contains a status element, it is referred to as a presence tuple and the information stored in the status element is typically referred to as presence information. In most cases, presence information is limited to information about the “owner” of the tuple, and in particular, to information about the owner's availability or status. The owner can publish its presence information as well as other information to its presence tuple and the published information can be presented to a watcher, which is an entity that receives presence information from a presence service on behalf of a presence client.

One problem with current presence tuples is that the status information is typically a single value, such as “available,” “online,” “busy,” or “away.” An owner's status, however, can seldom be accurately described by a single value. For example, a user or device may be “available” for one set of activities, but not available for another set. Similarly, the user may be “available” with respect to one set of people, but not available to another. In many cases, the user's status depends on one or more activities in which the user is engaged. Nonetheless, current presence tuples do not take into account relations in which the user is currently involved and that affect the user's status. For example, an existing presence tuple can provide status information that indicates that the user is “busy,” but does not indicate with whom or with what the user is “busy.” Thus, the status information can be misleading when the user is “busy” talking to a friend, but “available” to take telephone calls from coworkers.

To address this shortcoming, a multi-valued status format can be implemented that provides multiple status elements for a plurality of activities. This, however, can quickly become a problem when the user engages in several activities simultaneously with several different participants and the presence tuple becomes large and unmanageable. Moreover, because other participants are involved, duplicate information can be introduced across multiple tuples associated with the other participants.

Accordingly, there exists a need for methods, systems, and computer program products for providing status information that reflects the status of a principal in relation to other related principals such that the status information accurately indicates the availability of the principal.

### SUMMARY

Methods and systems are described for providing status information of at least two related principals. One method includes establishing an association between a first tuple including a first status for a first principal and a second tuple including a second status for a second principal, where the association includes a relationship indicator indicating a relationship between the first principal and the second principal. A first subscription to the first tuple for receiving the first status for the first principal is provided for a first watcher entity. In response to providing the first subscription, the method includes generating a first notification message including status information comprising at least one of a composite status based on the first status for the first principal, the second status for the second principal and the relationship indicator; and the first status, the second status, and the relationship indicator.

In another aspect of the subject matter disclosed herein, another method for providing status information of at least two related principals includes sending to a status service a subscription request to establish a first subcription to a first tuple including a first status for a first principal. An association is established between the first tuple and a second tuple including a second status for a second principal, the association including a relationship indicator indicating a relationship between the first principal and the second principal. The method also includes receiving a notification message in response to the subscription request. The notification message includes status information comprising at least one of a composite status based on the first status for the first principal, the second status for the second principal and the relationship indicator; and the first status, the second status and the relationship indicator.

In another aspect of the subject matter disclosed herein, a system for providing status information of at least two related principals includes a data store configured for storing a plurality of tuples associated with a plurality of principals, a status monitor component configured for establishing an association between a first tuple including a first status for a first principal and a second tuple including a second status for a second principal, wherein the association includes a relationship indicator indicating a relationship between the first principal and the second principal, and for providing for a first watcher entity a first subscription to the first tuple for receiving the first status for the first principal, and a notification handler component configured for generating a first notification message in response to establishing the first subscription, the first notification message including status information comprising at least one of a composite status based on the first status for the first principal, the second status for the second principal and the relationship indicator; and the first status, the second status and the relationship indicator.

In another aspect of the subject matter disclosed herein, another system for providing status information of at least two related principals includes a watcher user agent configured for generating a subscription request to establish a first subcription to a first tuple including a first status for a first principal, wherein an association is established between the first tuple and a second tuple including a second status for a second principal, the association including a relationship indicator indicating a relationship between the first principal and the second principal, and a watcher entity component configured for sending the subscription request to a status service and for receiving a notification message in response to the subscription request, a notification message including status information comprising at least one of a composite status based on the first status for the first principal, the second status for the second principal and the relationship indicator; and the first status, the second status and the relationship indicator.

In another aspect of the subject matter disclosed herein, a computer readable medium containing a computer program, executable by a machine, for providing status information of at least two related principals is disclosed. The computer program comprises executable instructions for establishing an association between a first tuple including a first status for a first principal and a second tuple including a second status for a second principal, where the association includes a relationship indicator indicating a relationship between the first principal and the second principal, for providing for a first watcher entity a first subscription to the first tuple for receiving the first status. The computer readable medium also includes executable instructions for generating a first notification message including status information comprising at least one of a composite status based on the first status for the first principal, the second status for the second principal and the relationship indicator; and the first status, the second status and the relationship indicator.

In another aspect of the subject matter disclosed herein, a computer readable medium containing a computer program, executable by a machine, for providing status information of at least two related principals comprises executable instructions for sending to a status service a subscription request to establish a first subcription to a first tuple including a first status for a first principal where an association is established between the first tuple and a second tuple including a second status for a second principal, the association including a relationship indicator indicating a relationship between the first principal and the second principal. The computer readable medium also includes instructions for receiving a notification message in response to the subscription request where the notification message includes status information comprising at least one of a composite status based on the first status for the first principal, the second status for the second principal and the relationship indicator; and the first status, the second status and the relationship indicator.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating an exemplary system for providing status information of at least two related principals according to an exemplary embodiment;

FIG. 2 is a block diagram illustrating an exemplary client device according to an exemplary embodiment;

FIG. 3 is a block diagram illustrating an exemplary status device according to an exemplary embodiment;

FIGS. 4A and 4B illustrate exemplary tuple format structures supporting association data according to exemplary embodiments;

FIG. 5A and FIG. 5B are flowcharts illustrating methods of providing status information of at least two related principals according to exemplary embodiments;

FIGS. 6A and 6B each depict a user interface displaying an exemplary composite status of a principal according to one embodiment; and

FIG. 7 is a message flow diagram showing a process of providing status information of at least two related principals according to one embodiment.

### DETAILED DESCRIPTION

Methods, systems, and computer program products for providing status information of at least two related principals are disclosed. According to one embodiment, a status service stores and manages a plurality of tuples associated with a plurality of principals. A principal can be associated with any entity, including a user, a device, an application, a service, and the like. Each of the tuples includes a status for its respective principal. In one embodiment, an association between at least two tuples can be established where the association includes a relationship indicator that indicates a relationship between the principals associated with the at least two tuples.

When a watcher entity is subscribed to a first of the at least two tuples, the status service generates a notification message that includes a representation of the status of the principal associated with the first tuple. In one embodiment, the representation can include the status of the principal associated with the first tuple, the status of a principal associated with the other of the at least two tuples, and the relationship indicator. In another embodiment, the representation can include a composite status for the first principal based on the statuses of the principals associated with the first tuple and at least one of the other of the at least two tuples and on the relationship indicator. For example, the composite status can be a graphical representation depicting the statuses in relation to one another and the relationships between the principals.

In one embodiment, the status service can send asynchronous notifications to the watcher entity using, for example, a publish/subscribe (pub/sub) communication protocol. In other embodiments, the status service can send notifications using traditional store and forward queuing services, such as electronic mail, as well as traditional Get-Request services. A notification can include only the most recent status change, in one embodiment, or can include changes queued and stored for the watcher entity when the watcher is offline or otherwise unsubscribed. In this case, when a watcher logs on or subscribes to the status service, the watcher can receive the current state of the information, as well as previous updates that may have occurred while the watcher was offline or unsubscribed.

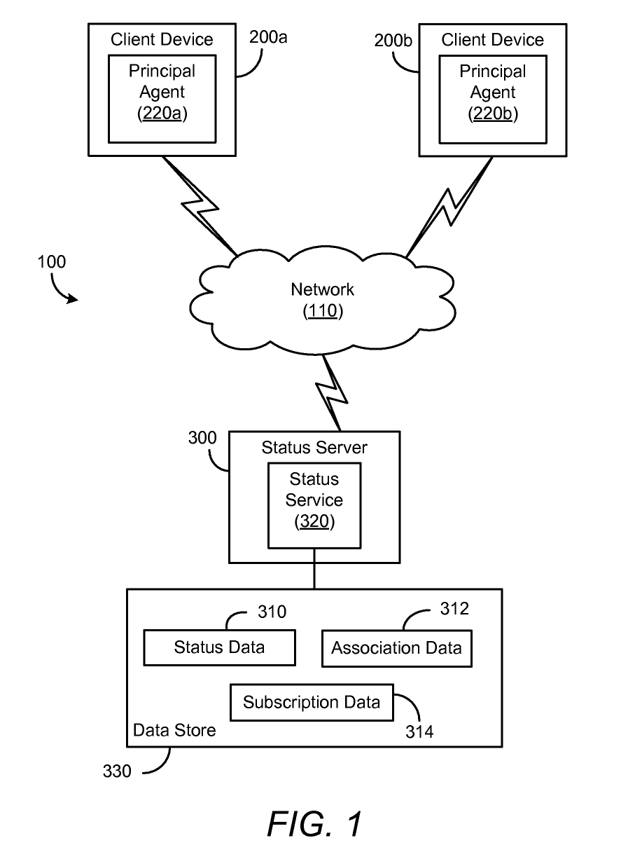

FIG. 1 is a block diagram illustrating an exemplary system according to one embodiment. The system 100 includes a plurality of client devices 200a, 200b communicatively coupled to a status device 300 by a network 110. The network 110 may be a Local Area Network (LAN) and/or a Wide Area Network (WAN) including the Internet. The status device 300 can by any device, e.g., a server, a laptop computer, a handheld phone, or a PDA, capable of sending and receiving messages over the network 110, and includes, in an exemplary embodiment, a status service 320 that manages and stores status data 310 and association data 312 in at least one data store 330. Status data 310, in one embodiment, can be stored in a status tuple associated with a principal and includes a status for the principal. According to an exemplary embodiment, association data 312 can include information identifying one or more principals related to a first principal and information describing the relationship between the first principal and each of the related principles.

In one embodiment, each client device 200a, 200b hosts a principal agent 220a, 220b. Each device 200a, 200b provides, for example, (not shown) a processor, operating system or control program, a network subsystem, input/output subsystems, and memory subsystems in order to provide an operating environment allowing the principal agent 220a, 220b to operate.

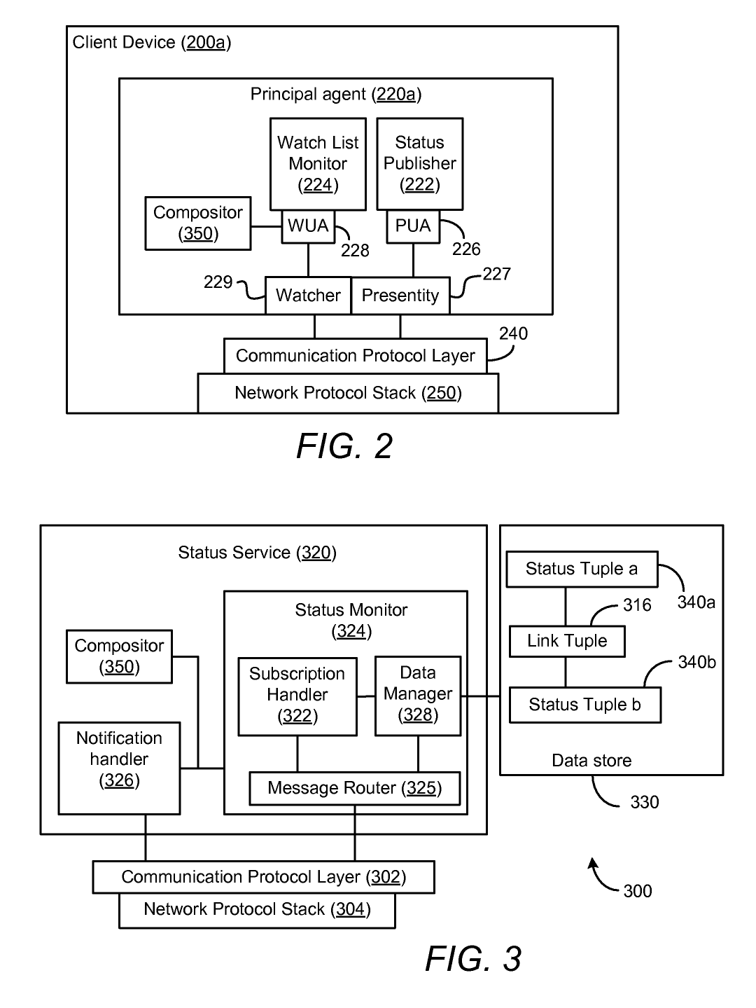

FIG. 2 is a block diagram showing an exemplary client device 200a according to one embodiment. Referring to FIG. 1 and FIG. 2, the principal agent 220a is capable of detecting and sending tuple information on behalf of a principal to the status service 320 over the network 110, as well as receiving information from the status service 320 over the network 110. In one embodiment, the principal agent 220a can be a presence client. As such, the principal agent 220a can include a status publisher component 222 that monitors the principal's status and publishes the principal's status to the status service 320 using a presentity 227 and presentity user agent 226. The principal agent 220a can also include a watch list monitor component 224 that sends subscription requests and receives notifications, respectively, from the status service 320 using a watcher user agent (WUA) 228 and a watcher entity component 229. In this embodiment, the principal agent 220a can use a presence protocol when sending and/or receiving information over the network 110.

In the embodiment shown in FIG. 2, the status publisher component 222 and the watch list monitor component 224 are depicted as separate components in the device 200a. In another embodiment, they can be integrated into one single component. In yet another embodiment, they can be separated completely and residing in different devices 200a, 200b. Other configurations are possible and the scope of the subject matter described herein is not limited to the configuration shown in FIG. 2.

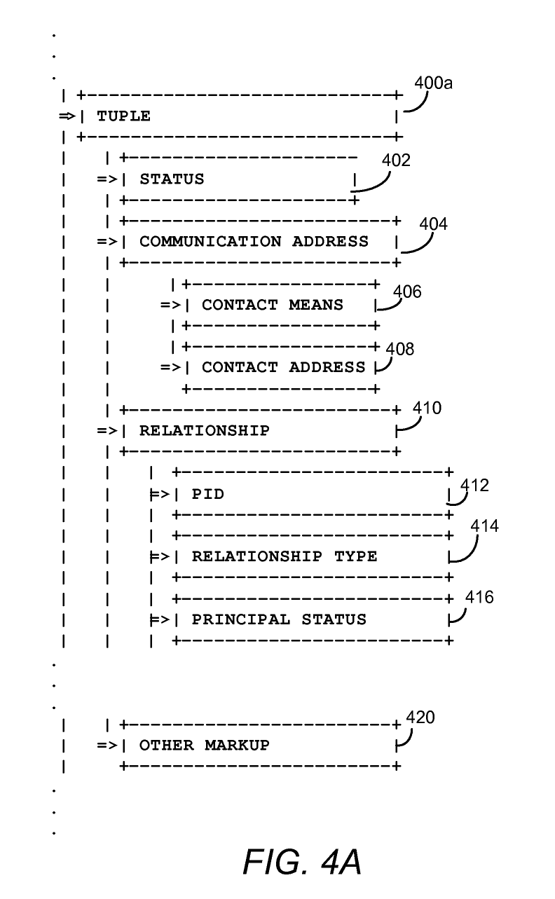

FIG. 3 is a block diagram illustrating an exemplary status device 300 that includes the status service 320 according to one embodiment. The status service 320, in one embodiment, manages and stores status data 310, association data 312 and subscription data 314 in at least one data store 330, as depicted in FIG. 1. In one exemplary embodiment, the data store 330 can be a relational database that includes a plurality of tables for storing the status data 310, association data 312, and the subscription data 314. For example, in one embodiment, the status data 310 can be stored in a table that associates an identifier of a principal with a status value for the principal. In addition, the association data 312 can be stored in a table that associates an identifier of a first principal with an identifier of a second principal that is related to the first principal and a relationship indicator indicating the relationship between the first principal and the second principal. The subscription data 314 can be stored in a table that associates an identifier of a principal with identifiers of a plurality of watcher entity components subscribed to the principal's status information. One skilled in the art can see that other data models can be used that serve similar purposes.

For instance, in another exemplary embodiment, the status 310 and association data 312 can be stored in data tuples in the data store 330. A tuple, in its broadest sense, is a data object containing one or more elements, any of which can be used to store and/or transmit information. The tuple can be a representation that maps field names to certain values to indicate that an entity or object includes certain components, information, and/or perhaps has certain properties.

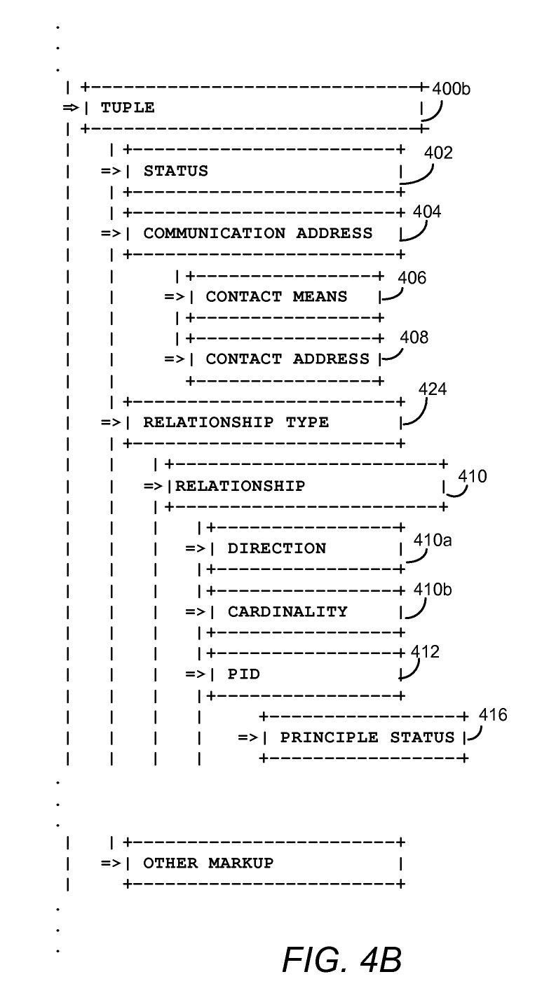

In one embodiment, the status data 310 and association data 312 associated with a principal can be stored as tuple information in a data tuple associated with the principal, such as that shown in FIG. 4A. The tuple 400a can include a status element 402 for providing a status of the principal represented by the tuple 400a. The status element 402 can be a single or multi-valued status and can include location information. An optional communication address element 404 can be included where the communication address element 404 includes zero or more pairs of contact means elements 406 and contact address elements 408. An “other markup” element 420 is depicted indicating that the format of the tuple 400a can be extended. The elements described above are well-known to those skilled in the art. For example, definitions and examples of the tuple elements described above can be found in “Request for Comments” (RFC) documents RFC 2778 to Day et al., titled “A Model for Presence and Instant Messaging” (February 2000), and RFC 2779 to Day et al., titled “Instant Messaging/Presence Protocol” (February 2000), which are published and owned by the Internet Society and incorporated here in their entirety by reference.

According to an exemplary embodiment, the tuple 400a also includes a relationship element 410 for indicating that the tuple 400a is associated with another tuple corresponding to a related principal. In one embodiment, the relationship element 410 can include at least one of a principal identifier (PID) element 412 for specifying the related principal, a relationship type element 414 for specifying a relationship type between the principal and the related principal, and a related principal status element 416 for indicating the status of the related principal identified in the (PID) element 412. In one embodiment, the related principal status element 416 can include a reference to a tuple associated with the related principal that includes the related principal's status. While the tuple in FIG. 4A depicts one relationship element 410, the tuple 400a can, in another embodiment, include a plurality of relationship elements 410 such that the tuple 400a can be associated with many other tuples associated with many other principals.

In another exemplary embodiment, the status data 310 and association data 312 associated with a principal can be stored in a data tuple, such as that shown in FIG. 4B. The tuple 400b includes the status element 402 and the optional communication address element 404 including zero or more pairs of contact means elements 406 and contact address elements 408 as described in the context of the exemplary tuple depicted in FIG. 4A. In this embodiment, however, the association data is organized by relationship type. Here, a relationship type element 424 is provided with a format allowing it to include information for relationships matching the type value of the relationship type element 424. Zero or more relationship elements 410 can be included in a relationship type element 424. In one embodiment, a relationship element 410 can include a PID element 412 for identifying a related principal and the PID element 412 includes a principal status element 416 for providing status information associated with the related principal.

In another embodiment, the relationship element 410 can include a direction element 410a for indicating the direction of the relationship from the principal of the tuple 400b to the related principal identified by the PID element 412, vice versa, or bidirectional. A cardinality element 410b can also be provided for indicating the relationship's cardinality. One skilled in the art can see that numerous other tuple formats can be used and that any tuple format can be made extensible as illustrated by the other markup element 420.

Referring again to FIG. 3, the status service 320 can be a presence service that uses a presence protocol to send and receive information to and from the plurality of client devices 200a, 200b in one embodiment. The status service 320 can include a status monitor component 324 and a notification handler component 326. In one embodiment, the status monitor component 324 can be configured for receiving status data 310 and association data 312 from the plurality of principal agents 220a, 220b via the network 110. The status monitor component 324 can also receive and process a subscription to the status data 310 depicted in FIG. 1 associated with a principal. The notification handler component 326 can be configured to generate and send notification messages to watchers including subscribers via the network 110. In an exemplary embodiment, a notification message can include a representation of a first principal's status that not only includes the first principal's status but also includes information based on the status of one or more related principals, and indicators indicating the relationship between the first principal and the related principals. Thus, the representation of the first principal's status can reflect more accurately the actual status of the first principal.

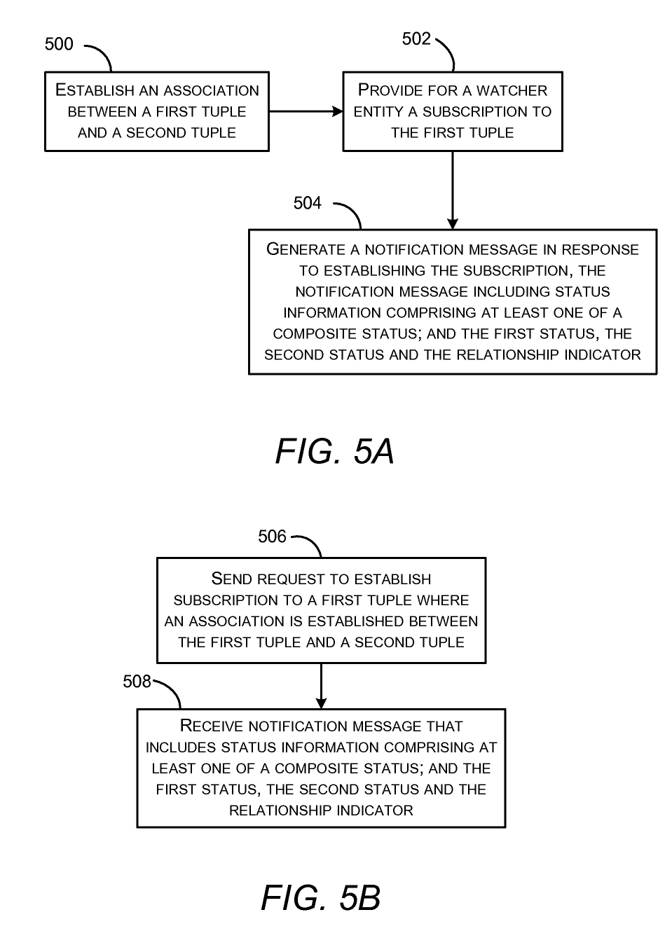

FIG. 5A is a flowchart of an exemplary method for providing status information of at least two related principals from a perspective of the status service 320 according to one embodiment. Referring to FIGS. 1-4, the process begins by establishing an association between a first tuple 340a that includes a first status for a first principal and a second tuple 340b having a second status for a second principal (block 500). In an exemplary embodiment, the association includes a relationship indicator indicating a relationship between the first principal and the second principal. In one embodiment, the relationship indicator can include the relationship type, cardinality information, direction information, and any other characteristic describing the relationship. The association can be established in several ways. For example, the association can be established by including a reference in a tuple to another related tuple or by using a link tuple including information identifying related tuples and any other data, as described above.

For example, in one embodiment, a first principal agent 220a (FIG. 1) can send a message to the status service 320 providing tuple information including a first status of a first principal represented by the first principal agent 220a. In this embodiment, the message can also include information providing a relationship indicator for indicating a relationship between a first status tuple 340a for the first principal agent 220a and a second status tuple 340b for a second principal agent 220b representing a second principal.

The message, for example, can be in the form of one of the tuples described previously in FIG. 4A and FIG. 4B. Here, information identifying the second principal agent 220b, e.g., the PID of the second principal agent 220b, and information describing the relationship between the first principal and the second principal can be provided by the first principal agent 220a in the relationship element 410. Note that the status element 416 of the second principal agent 220b is usually not provided by the publishing principal agent 220a because the first principal agent 220a typically will not have direct means for determining the status of another principal agent.

While an association can be established using the exemplary tuple format described in FIGS. 4A and 4B, an association can also be removed using the same tuple format. For example, the first principal agent 220a can remove an existing relationship indicator by providing the PID of a principal agent 220b included in the relationship and either not providing a relationship type element 414, providing a relationship type element 414 with no value, or providing a relationship type element 414 with a specified type indicating no relationship, such as a null relationship indicator.

The association between tuples, e.g., 340a, 340b can be created by means other than messages sent from principal agents 220a, 220b. For example, in another embodiment, a user interface for display via a browser can be supported by the status service 320, which allows users, e.g., tuple owners, and status device 300 administrators to submit requests to add or remove associations between a plurality of tuples. Such requests can be submitted using, for example, a request protocol, such as HTTP.

According to one embodiment, the status service 320 includes a status monitor component 324 configured to receive the message/request including the association and to establish the association indicating a relationship. In one embodiment, the status monitor component 324 receives the message via a network protocol stack 304, which routes the request to a communication protocol layer 302 supported by the status service 320. The communication protocol layer 302 then passes the request to a listening message router 325 in the status monitor component 324, which determines that the message includes an association indicating a relationship and, as a result, passes the request to the status monitor component 324.

When the message or request that includes the association is received, the status monitor component 324 can update or create the first status tuple 340a and/or the second status tuple 340b. For example, the status monitor component 324 can store the association in the first status tuple 340a and/or in the second status tuple 340b. In another embodiment, the status monitor component 324 can create or update a link tuple 316 associated with the first status tuple 340a and/or the second status tuple 340b. In one embodiment, the link tuple 316 links the first status tuple 340a with the second status tuple 340b indicating a relationship between the tuples 340a, 340b and thus the principals. Link tuples 316 support relationships of all cardinalities and support unidirectional and bidirectional relationships. The link tuple 316 can include status information in some embodiments, thereby allowing a subscriber to be notified of the status of associations, e.g., added or removed, relating to a principal. Once the association is established, the first principal and the second principal are related via their respective status tuples 340a, 340b.

In one embodiment, when the status monitor component 324 creates the first status tuple 340a for the first principal and establishes the association between the first status tuple 340a and the second status tuple 340b, it automatically provides a subscription for the first principal agent 220a to the first status tuple 340a. In this manner, the first principal agent 220a can be notified of changes to the first status tuple 340a and/or to the second status tuple 340b. This feature will be described in more detail below.

Once the association between the first status tuple 340a and the second status tuple 340b is established (block 500), the status service 320 receives a subscription request and provides, for the watcher entity 229 identified in the subscription request, a subscription to the first tuple 340a (block 502). According to one embodiment, the status monitor 324 in the status service 320 includes a subscription handler component 322 for creating and managing subscriptions to the status tuples 340a, 340b. Alternately, a subscription for the watcher entity 229 can exist at the time of the association between the first status tuple 340a and the second status tuple 340b as a result of receiving an earlier subscription request to the first tuple 304a.

In one embodiment, the subscription handler component 322 receives the subscription request via a network stack 304, which routes the request to a communication protocol layer 302 supported by the status service 320. The communication protocol layer 302 then passes the request to a listening message router 325 in the status monitor component 324, which determines that the request is a subscription request and, as a result, passes the request to the subscription handler component 322. In another exemplary embodiment, the message router 325 is external to the status monitor component 324. In this embodiment, when the message router 325 determines that the request includes a subscription request, it passes the subscription request to the subscription handler component 322.

According to one embodiment, the subscription handler component 322 receives the subscription request and can establish the subscription based on the content of the subscription request. The subscription handler component 322 can create or update a subscription list for the first tuple 340a and place the watcher entity 229 on the list. In some embodiments, the subscription request can identify other watcher entities 229 that may or may not be associated with the device, e.g., 200b, from which the subscription request is received. Accordingly, those watcher entities 229 can also be placed on the subscription list. The subscription handler component 322 can use a data manager component 328 to store the subscription list and other subscription data 314 in the data store 330, as shown in FIG. 1 and FIG. 3, or in a separate local or remote data store (not shown).

Referring again to FIG. 5A, in response to establishing the subscription, the status service 320 generates a notification message that includes status information having at least one of a composite status based on the first status for the first principal, the second status for the second principal and the relationship indicator; and the first status, the second status and the relationship indicator (block 504). In an exemplary embodiment, the status service 320 includes a notification handler component 326 configured to generate the notification message that includes status information comprising at least one of a composite status based on the first status for the first principal, the second status for the second principal and the relationship indicator; and the first status, the second status and the relationship indicator.

In one embodiment when the subscription is provided, the subscription handler component 322 can retrieve status information comprising tuple information from the first status tuple 340a associated with the subscription. Based on the association data 312 of the first tuple 340a, the subscription handler component 322 can determine that the first tuple 340a is related to the second tuple 340b and can determine the relationship type from the perspective of the first tuple 340a. As stated above, the association data 312 that includes the relationship indicator can be stored in the first tuple 340a, the second tuple 340b, or in the link tuple 316 associated with the first 340a and/or second 340b status tuples. In response to determining the relationship between the first 340a and second 340b tuples, the subscription handler component 322 can retrieve status information from the second status tuple 340b including the status.

The subscription handler component 322 can provide the retrieved status information, i.e., the tuple information from the first tuple 340a including the first status of the first principal, the relationship indicator of the first tuple 340a, and the tuple information from the second tuple 340b including a second status of the second principal, to the notification handler component 326 along with information for addressing a notification message to the watcher entity 229 identified by the subscription.

According to one embodiment, the subscription handler component 322 can be configured to filter at least a portion of the status information based on at least one of the relationship indicator and other tuple information included in the first tuple 340a and the second tuple 340b. For example, the status information can be filtered based on the relationship type. Status information may be filtered, for example, using tuple information including type information identifying a principal as a person, a device, or a service; location information; activity information; and organization information including employer and civic organizations. Such filters can be configured by watcher entities 229, system administrators, and/or publishers 222.

In another embodiment, the subscription handler component 322 can determine a portion of the status information based on conditional and/or contextual data. For example, in one embodiment, a policy tuple described in co-pending U.S. patent application Ser. No. 11/306,341, entitled “METHODS, SYSTEMS, AND COMPUTER PROGRAM PRODUCTS FOR ASSOCIATING POLICIES WITH TUPLES USING A PUB/SUB PROTOCOL,” filed on Dec. 23, 2005, commonly owned with the present application, and incorporated here by reference in its entirety, can be used to detect a condition or context in which an action handler component can be invoked to implement conditional filtering.

In another embodiment, the subscription handler component 322 can filter the status information based on the values in particular status and relationship elements, which may be specific to a relationship type. For example, the status information can be filtered based on elements having a particular status, e.g., “active,” and a particular location, e.g., “work.” For instance, when the unfiltered, e.g., raw, status and association information includes:
((admin assistance, online, home), (spouse, online, spouse's work location), (phone, busy, work), (car, off, work), (laptop, active, work), (browser, active, laptop))
   the filtered information can include:
((phone, active, work) (laptop, active, work), (browser, active, laptop))

According to an exemplary embodiment, when the notification handler component 326 receives the status information from the subscription handler component 322, the notification handler component 326 can construct a notification message including the status information comprising the first status of the first principal, the second status of the second principal, and the relationship indicator in response to the subscription request. The notification message can also include other information, such as type information of the related principals, role information, relationship weights, direction, cardinality, age of relationship, and time since last change. The notification message can have a format compatible with the tuples described in FIG. 4A and FIG. 4B, or any of a number of tuple formats supporting the required information.

In another exemplary embodiment, the notification handler component 326 can invoke a compositor component 350, which generates a composite status for the first principal based on the first status of the first principal, the second status of the second principal and the relationship indicator of the association between the first tuple 340a and the second tuple 340b. In one embodiment, the composite status can be a graphical representation of the statuses of the first principal and the second principal, and the relationship between the first principal and the second principal.

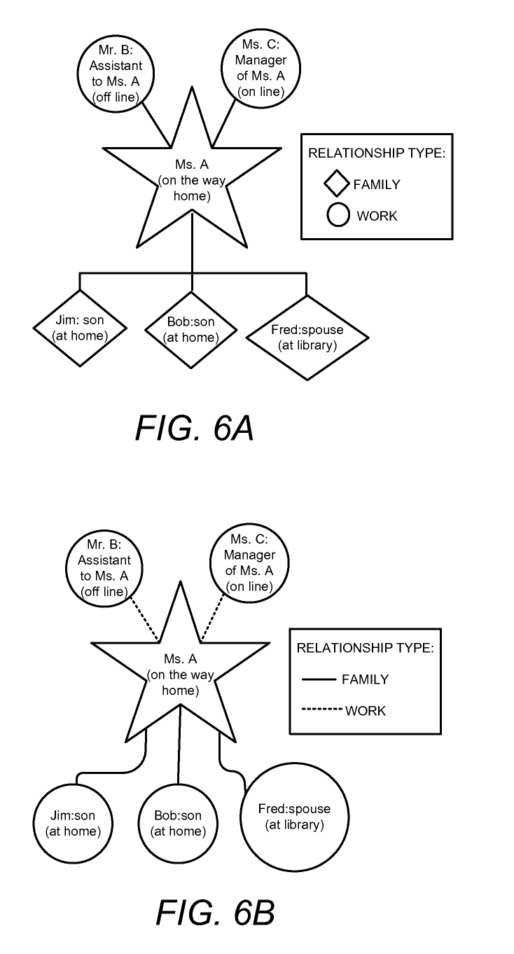

For example, FIG. 6A depicts an exemplary composite status for the first principal, where the first principal is represented by a star at the center, with related principals represented by other shapes emanating from the star where the status of each principal is provided in the shape and the shape indicates the relationship type. In another example, shown in FIG. 6B, the first principal is represented by a star at the center of the composite status, with related principals represented by circles emanating from the first principal where the status of each principal is indicated in the shape and the connecting lines indicate the relationship type. In another example, the first principal's status can be indicated by a shape and color at the center of the composite status, with related status values corresponding to rays emanating from the first principal's status where the status of a related principal affects the length, color, pattern, and/or texture, for example, of a ray in the graphic representation. One skilled in the art can see that there are many possible graphic and non-graphic composite status representations that can be used according to the requirements of the system disclosed.

According to one embodiment, the notification handler component 326 transmits the notification message that includes the status information to the subscribed watcher entity 229 via the network 110 using the communication protocol layer 302 interoperating with the network stack 304.

FIG. 5B is a flowchart of an exemplary process for providing status information of at least two related principals from a perspective of the client device 200b according to one embodiment. According to the exemplary method, the process begins when a watcher entity 229 in a principal agent (shown in FIG. 2), sends a subscription request to the status service 320 to establish a subscription to a first status tuple, where an association is established between the first status tuple and a second status tuple (block 506). For example, the subscription request can be to establish a subscription to the first status tuple 340a for the first principal represented by the first principal agent 220a, which is associated with the second status tuple 340b for the second principal represented by the second principal agent 220a.

In one embodiment, a watch list monitor component 224 in a principal agent can provide an interface for receiving an input initiating, terminating, and/or otherwise managing subscriptions, as well as for presenting tuple information associated with watched tuples based on notifications received. When the watch list monitor component 224 receives an input relating to a subscription request, the watch list monitor 224 can instruct the WUA 228 to send the subscription request to the status service 320 for the indicated tuple, e.g., the first status tuple 340a. The WUA 228 provides an interface between the watch list monitor 224 and the watcher entity component 229. The watcher entity 229 is configured to interoperate with the status service 320 using an agreed upon protocol. Subscription requests and notifications can and are supported by a number of get/request protocols, and email using any of a number of current email protocols. In one embodiment, a presence protocol can be used, such that the communication protocol layer 240 supports the presence protocol.

When the WUA 228 is invoked by the watch list monitor 224 to send the subscription request, the watcher entity 229 constructs a message that includes subscription information identifying the tuple 340a to be watched and information for addressing a notification message to the subscribing watcher entity 229. The watcher entity 229 then sends the message via the communication protocol layer 240 operatively coupled to a network protocol stack 250, such as a TCP/IP stack, over the network 110 to the status service 320.

In the embodiment described above, the watcher entity 229 is associated with the principal agent 220b interested in watching the tuple 340a. In another embodiment, the principal agent 220b can initiate a subscription request for a different watcher entity associated with a different principal agent. For example, the requesting principal agent 220b can be associated with a group administrator who is responsible for establishing subscriptions to a status tuple on behalf of all members of the group.

In response to the subscription request, the watcher entity 229 receives a notification message that includes status information comprising at least one of a composite status based on a first status for the first principal, a second status for the second principal and a relationship indicator; and the first status, the second status and the relationship indicator (block 508). In the one embodiment, the watcher entity 229 receives the notification message via the network 110 as provided for by the network stack 250 and the communication protocol layer 240. The watcher entity 229 parses the notification message, in an embodiment, and provides the parsed status information in the notification message to the WUA 228, which processes the status information so that at least a portion of the status information can be presented by the watch list monitor 224.

In one embodiment, the status information in the notification message can be filtered based on at least one of the relationship indicator and other tuple information included in the first tuple 340a and the second tuple 340b in a manner similar to that described above. For example, the status information may be filtered based on the tuple information including type information identifying a principal as a person, a device, or a service; location information; activity information; and organization information including employer and civic organizations.

In one embodiment when the status information includes the first status, the second status and the relationship indicator, e.g., raw status information, the watch list monitor 224 can present the raw status information visually. In another embodiment, the WUA 228 can invoke a compositor component 350 in the principal agent 220b to create a composite status for the first principal based on the status of the first principal, a relationship indicator, and the status of a second principal in the relationship indicated by the relationship indicator. The WUA 228 can then pass the composite status to the watch list monitor 224 for presentation. In another embodiment, the raw status information can be reformatted to form a multi-valued status representation based on the first status, the second status, and the relationship indicator and then presented.

In another embodiment when the status information includes the composite status for the first principal, the received composite status can be presented in a visual format. In other embodiments, the composite status can be reformatted to form a modified composite status based on the first status, the second status, and the relationship indicator. In another embodiment, the received composite status can be deconstructed into a multi-valued status for the first principal based on the status of the first principal, a relationship indicator, and the status of a second principal in the relationship indicated by the relationship indicator.

According to exemplary embodiments, the status information for a principal provided by the method and system described herein can convey the principal's status in relation to other related principals thereby providing more information and a more accurate description of the principal's availability. For example, using the exemplary composite status depicted in FIG. 6A or FIG. 6B, a subscribing principal can be preparing dinner for the first principal's family and based on the status information can determine that the first principal is “on the way home,” that her two sons are “at home,” but that her spouse is “at the library.” Accordingly, the subscribing principal can contact the spouse and instruct the spouse to come home for dinner.

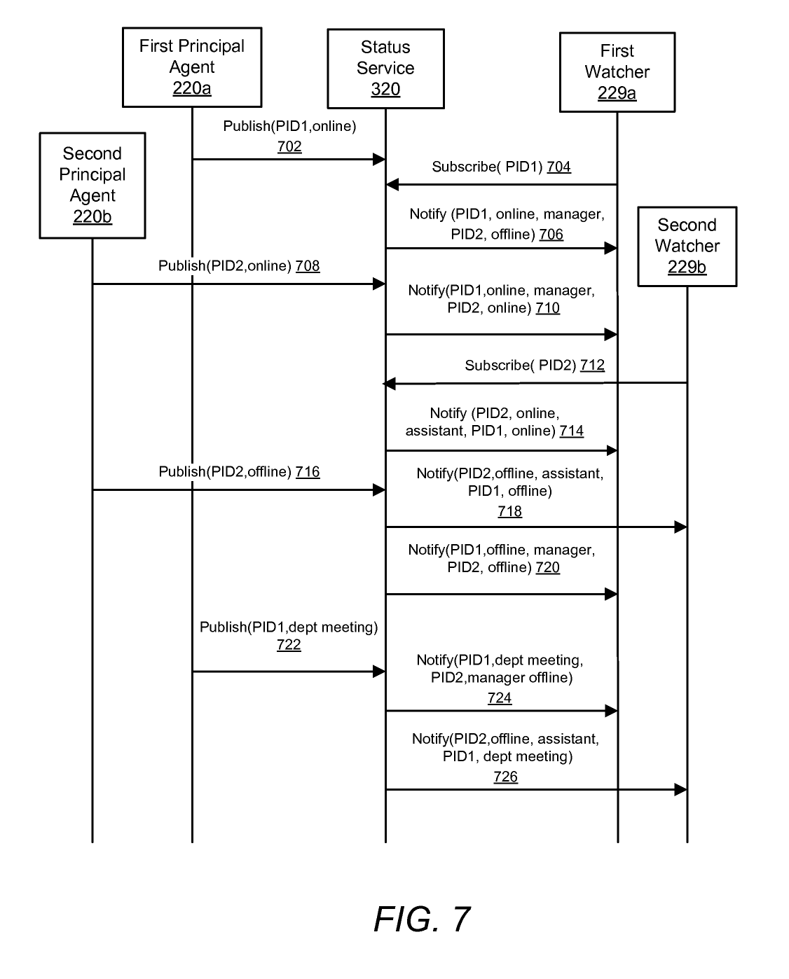

To illustrate further the aspects of one embodiment, FIG. 7 is a message flow diagram showing a process of providing status information of at least two related principals according to one embodiment. In the exemplary message flow, a first principal agent, e.g., 220a, sends a publish message (702) to the status service 320 providing tuple information including the identifier of the first principal, e.g., PID1, and the first status, e.g., “online,” of the first principal represented by the first principal agent 220a.

The message (702) can also include association information including a relationship indicator for indicating a relationship between a first tuple 340a associated with the first principal agent 220a and a second tuple 340b associated with a second principal agent 220b representing a second principal. In this case, the status service 320 establishes the association between the tuples 340a, 340b and in one embodiment, provides a subscription to the first tuple 340a to the first principal agent 220a that published the first status.

After the status service 320 receives the publish message and creates the association between the first tuple 340a and the second tuple 340b, assuming the association is not already established, a first watcher entity 229a sends to the status service 320 a subscribe message (704) subscribing to the first tuple 340a associated with the first principal agent 220a. In response to subscribing the first watcher entity 229a to the first tuple 340a, the status service 320 generates and sends a notification message (706) that includes status information comprising, in this exemplary process, the first principal's identifier, the first status of the first principal, the relationship indicator indicating the relationship between the first principal and the second principal, the identifier associated with the second principal and the second status of the second principal. For example, in this embodiment, the first principal is “online,” the second principal is “offline,” and the second principal is the first principal's “manager.” According to an exemplary embodiment, the first watcher entity 229a can receive the status information and present the raw status data and/or create and present a composite status for the first principal based on the status information.

Subsequently, the second principal agent 220b sends a publish message (708) to the status service 320 including the second status of the second principal. The publish message can also include association information for establishing a relationship between the second principal tuple 340b and the first principal tuple 340a or the relationship can have been previously established. The publish message (708) identifies the second principal and includes status information indicating the second principal is “online.”

In response to receiving the publish message, the status service 320 updates the second principal status tuple 340b. According to an exemplary embodiment, in response to updating the second tuple 340b, the status service 320 generates a notification message (710) to send to subscribers to the second tuple 340b and to subscribers to the first principal tuple 340a, e.g., the first watcher entity 229a, due to one of the established relationships between the first 340a and second 340b tuples. The notification message (710) includes the status of the first principal, “online,” the updated status of the second principal, “online,” and the relationship indicator indicating that the second principal is the “manager” of the first principal. Accordingly, the first watcher entity 229a, which is subscribed to the first tuple 340a only, can receive updates to the status of principals related to the first principle as well as updates to the status of the first principal.

In one embodiment, where the first principal agent 220a is subscribed to its own status tuple 340a because of the association, the status service 320 also sends the notification message (710) to the first principal agent 220a. In this case, although the first principal's status is unchanged, the first principal can be notified of changes to the status of the related principal, i.e., the second principal, via the updated status and/or via the composite status of the first principal, without having to subscribe to the second principal's status tuple 340b.

Next, a second watcher entity 229b sends a subscribe message (712) to subscribe to notifications associated with changes to the second tuple 340b. The status service 320 receives the subscription message, establishes a subscription to the second tuple 340b on behalf of the second watcher entity 229b. In response to the subscription, the status service 320 sends a notification message (714) including the current status of the second principal as well as the status of the first principal and a relationship indicator. The relationship indicator indicates that the first principal is an “assistant” of the second principal.

Next, the second principal agent 220b sends another publish message (716) including an update to the second principal's status, e.g., “offline.” The publish message (716) is received by the status service 320, which updates the second tuple 340b with the updated status information including the “offline” status. The status service 320 generates and sends a notification message (718) to the second watcher entity 229b based on its subscription to changes in the second tuple 340b. According to an exemplary embodiment, a notification message (720) is also sent to the first watcher 229a based on the relationship indicator indicating a relationship between the first principal tuple 340a and the second principal tuple 340b.

The notification message (718) to the second watcher entity 229b includes a multi-valued status for the second principal based on the updated status of the second principal, the status of the first principal, and the relationship indicator previously discussed. The notification message (720) to the first watcher entity 229a includes a multi-valued status for the first principal based on the status of the first principal, “offline”, the updated status of the second principal, “offline”, and the relationship indicator previously discussed. As noted above, even though the tuple information in the first principal tuple 340a has not changed, watchers of the first principal tuple 340a can receive a notification because of the relationship between the first principal tuple 340a and the second principal tuple 340b and a change in the status in the second principal tuple 340b. Moreover, as demonstrated in this example, watchers of the first principal tuple 340a can receive status updates even when the watched principal, e.g., the first principal agent 220a, is offline.

Next, the first principal agent 220a sends a publish message (722) including an update to the status of the first principal to the status service 320. For example, the updated status can indicate that the first principal is in a department meeting. The status service 320 receives the publish message (722) and updates the first principal tuple 340a. In response to updating the tuple 340a, the status server 320 sends a notification message (724) to the first watcher entity 229a found in the subscription list for the first principal tuple 340a. The notification message (724) includes status information indicating that the first principal is in a department meeting and the manager of the first principal, the second principal, is “offline.” Moreover, based on one of the relationships between the first 340a and second 340b principal tuples, the status service 320 sends a notification message (726) to the second watcher 229b that includes status information indicating that the second principal is “offline,” the first principal is in a department meeting and is the assistant of the second principal. Both the first watcher 229a and the second watcher 229b can surmise that there is a reasonable probability that the second principal is in the department with the first principal based on their relationships and the status of the first principal.

In one embodiment, the notification messages are asynchronous messages, that is, they are received without a corresponding request. A notification message, whether asynchronous or synchronous, may be received substantially simultaneously when the change is published. In another exemplary embodiment, the notification message can be received when a subscriber logs in to the status service 320 or when a subscriber requests the changed status data. In another embodiment, a client can receive the notification message pursuant to a fetch request. For example, the WUA 228 can receive an instruction to fetch status information associated with a principal status tuple 340a. The watcher entity 229 can generate a fetch request and send it to the status service 320 via the network 110. In this manner, the watcher entity 229 can receive a notification message including the current status information pursuant to a fetch request.

According to aspects of the embodiments described, a graph of relationships among the friends may be presented instead of showing a list of friends. Colors, line thickness, line pattern (solid, dashed, dotted, etc), and line length may be associated with characteristics of the relationships providing a user with a “rich” view. That is, a single display can convey a great deal of status information without the use of text. Further, the relationship graph can be dynamic. Relationship updates may be logged allowing reconstruction of relationship graphs at a specified point in time, and allowing a replay of the changes occurring in a graph between a starting time point and an ending time point. In one embodiment, a relationship can be selected in order to display more information, and/or to provide commands/actions that may be sent to one or more of the entities in the relationship. In other embodiments, the visual format of the status information can be modified.

Through aspects of the embodiments described, the statuses of a first principal and principals related to the first principal can be provided by a status service 320. It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing status information of at least two related principals, the method comprising:
establishing an association between a first tuple including a first status for a first principal and a second tuple including a second status for a second principal, wherein the association includes a relationship indicator indicating a relationship between the first principal and the second principal;
providing for a first watcher entity a first subscription to the first tuple for receiving the first status for the first principal; and
generating a first notification message in response to providing the first subscription, the first notification message including status information comprising at least one of a composite status based on the first status for the first principal, the second status for the second principal and the relationship indicator; and the first status, the second status and the relationship indicator.

2. The method of claim 1 wherein establishing the association includes receiving a first message from a first agent associated with the first principal, the first message including a relationship element for carrying information identifying the second principal and information describing the relationship between the first principal and the second principal.

3. The method of claim 1 further including:
receiving from a second agent associated with the second principal a second message including an updated second status for the second principal;
updating the second tuple with the updated second status for the second principal;
generating a second notification message in response to updating the second tuple, the second notification message including at least one of a composite status based on the first status for the first principal, the updated second status for the second principal and the relationship indicator; and the first status, the updated second status and the relationship indicator; and
sending the second notification message to the first watcher entity pursuant to at least one of the association between the first tuple and the second tuple, and the first subscription, wherein the first watcher entity is notified of the updated status of the second principal via at least one of the composite status and the updated second status even when the first status of the first principal remains unchanged.

4. The method of claim 3 further including:
providing for a first agent associated with the first principal a subscription to the first tuple in response to establishing the association between the first tuple and the second tuple; and
sending the second notification message to the first agent based on the subscription to the first tuple, wherein the first principal is notified of the updated status of the second principal via at least one of the composite status and the updated second status even when the first status of the first principal remains unchanged.

5. The method of claim 3 wherein the first watcher entity is notified of the updated status of the second principal pursuant to the first subscription even when the first status of the first principal is offline.

6. The method of claim 1 wherein at least one of providing for the first subscription and sending the first notification message comprises using a presence service and a presence protocol to at least one of receive the subscription request and send the first notification message.

7. The method of claim 1 wherein the relationship indicator includes information identifying the first principal and the second principal and information describing the relationship between the first principal and the second principal.

8. The method of claim 1 wherein establishing the association includes storing the association in at least one of the first tuple, the second tuple and a link tuple associated with at least one of the first tuple and the second tuple.

9. The method of claim 8 wherein the link tuple includes a status for the association between the first tuple and the second tuple and wherein the method includes providing a subscription to the link tuple for receiving updates to the status for the association.

10. The method of claim 1 wherein generating the first notification message includes filtering at least a portion of the status information based on at least one of the relationship indicator and other tuple information included in the first tuple and the second tuple.

11. A method for providing status information of at least two related principals, the method comprising:
sending to a status service a subscription request to establish a first subcription to a first tuple including a first status for a first principal, wherein an association is established between the first tuple and a second tuple including a second status for a second principal, the association including a relationship indicator indicating a relationship between the first principal and the second principal; and
receiving a notification message in response to the subscription request, the notification message including status information comprising at least one of a composite status based on the first status for the first principal, the second status for the second principal and the relationship indicator; and the first status, the second status and the relationship indicator.

12. The method of claim 11 wherein at least one of sending the subscription request and receiving the notification message comprises using a presence service and a presence protocol to at least one of send the subscription request and receive the notification message.

13. The method of claim 11 further including presenting at least a portion of the status information in the notification message based on at least one of the relationship indicator, the first status and the second status.

14. The method of claim 13 wherein when the status information comprises the first status, the second status and the relationship indicator, presenting the status information includes creating a composite status based on the status information, wherein the composite status is a graphical representation of the first status for the first principal, the second status for the second principal and the relationship between the first principal and the second principal.

15. A system for providing status information of at least two related principals, the system comprising:
a data store configured for storing a plurality of tuples associated with a plurality of principals;
a status monitor component configured for establishing an association between a first tuple including a first status for a first principal and a second tuple including a second status for a second principal, wherein the association includes a relationship indicator indicating a relationship between the first principal and the second principal, and for providing for a first watcher entity a first subscription to the first tuple for receiving the first status for the first principal; and
a notification handler component configured for generating a first notification message in response to establishing the first subscription, the first notification message including status information comprising at least one of a composite status based on the first status for the first principal, the second status for the second principal and the relationship indicator; and the first status, the second status and the relationship indicator.

16. The system of claim 15 wherein at least one of the status monitor component and the notification handler component is further configured to provide the subscription and to send the first notification message, respectively, using a presence protocol.

17. The system of claim 15 wherein the status monitor component is configured for receiving a first message from a first agent associated with the first principal, the first message including a relationship element for carrying information identifying the second principal and information describing the relationship between the first principal and the second principal.

18. The system of claim 15 wherein the status monitor component is further configured for receiving from a second agent associated with the second principal a second message including an updated second status for the second principal, for updating the second tuple with the updated second status for the second principal, and wherein the notification handler component is configured for generating a second notification message in response to updating the second tuple, the second notification message including at least one of a composite status based on the first status for the first principal, the updated second status for the second principal and the relationship indicator; and the first status, the updated second status and the relationship indicator, and for sending the second notification message to the first watcher entity pursuant to at least one of the association between the first tuple and the second tuple and the first subscription, wherein the first watcher entity is notified of the updated status of the second principal via at least one of the composite status and the updated second status even when the first status of the first principal remains unchanged.

19. The system of claim 18 wherein the status monitor component is configured for providing for a first agent associated with the first principal a subscription to the first tuple in response to establishing the association between the first tuple and the second tuple and for sending the second notification message to the first agent based on the subscription to the first tuple, wherein the first principal is notified of the updated status of the second principal via at least one of the composite status and the updated second status even when the first status of the first principal remains unchanged.

20. The system of claim 18 wherein the first watcher entity is notified of the updated status of the second principal pursuant to the first subscription even when the first status of the first principal is offline.

21. The system of claim 15 wherein the status monitor component is configured for storing the association between the first tuple and the second tuple in at least one of the first tuple, the second tuple, and a link tuple associated with at least one of the first tuple and the second tuple.

22. The system of claim 16 wherein the link tuple includes a status for the association between the first tuple and the second tuple and wherein the status monitor component is configured for providing a subscription to the link tuple for receiving updates to the status for the association.

23. The system of claim 15 wherein the status monitor component is configured for filtering at least a portion of the status information based on at least one of the relationship indicator and other tuple information included in the first tuple and the second tuple.

24. A system for providing status information of at least two related principals, the system comprising:
a watcher user agent configured for generating a subscription request to establish a first subcription to a first tuple including a first status for a first principal, wherein an association is established between the first tuple and a second tuple including a second status for a second principal, the association including a relationship indicator indicating a relationship between the first principal and the second principal; and
a watcher entity component configured for sending the subscription request to a status service and for receiving a notification message in response to the subscription request, a notification message including status information comprising at least one of a composite status based on the first status for the first principal, the second status for the second principal and the relationship indicator; and the first status, the second status and the relationship indicator.

25. The system of claim 24 wherein the watcher user agent is configured for presenting at least a portion of the status information in the notification message based on at least one of the relationship indicator, the first status and the second status.

26. The system of claim 24 further comprising a compositor component configured for creating a composite status based on the received status information, wherein the composite status is a graphical representation of the first status for the first principal, the second status for the second principal and the relationship between the first principal and the second principal.

27. A computer readable medium containing a computer program, executable by a machine, for providing status information of at least two related principals, the computer program comprising executable instructions for:
establishing an association between a first tuple including a first status for a first principal and a second tuple including a second status for a second principal, wherein the association includes a relationship indicator indicating a relationship between the first principal and the second principal;
providing for a first watcher entity a first subscription to the first tuple for receiving the first status for the first principal; and
generating a first notification message in response to establishing the first subscription, the first notification message including status information comprising at least one of a composite status based on the first status for the first principal, the second status for the second principal and the relationship indicator; and the first status, the second status and the relationship indicator.

28. A computer readable medium containing a computer program, executable by a machine, for providing status information of at least two related principals, the computer program comprising executable instructions for:
sending to a status service a subscription request to establish a first subcription to a first tuple including a first status for a first principal, wherein an association is established between the first tuple and a second tuple including a second status for a second principal, the association including a relationship indicator indicating a relationship between the first principal and the second principal; and;
receiving a notification message in response to the subscription request, the notification message including status information comprising at least one of a composite status based on the first status for the first principal, the second status for the second principal and the relationship indicator; and the first status, the second status and the relationship indicator.
